(19) United States
(12) Patent Application Publication
(10) Pub. No.: US 2011/0014556 A1
(43) Pub. Date: Jan. 20, 2011

(54) CHARGE ACCEPTANCE STABILIZER CONTAINING CHARGE TRANSPORT LAYER

(75) Inventors: Gregory McGuire, Oakville (CA); Ah-mee Hor, Misslssauga (CA)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/506,150

(22) Filed: Jul. 20, 2009

(51) Int. Cl. G03G 15/00; G03G 5/04

(52) U.S. Cl. 430/56; 399/159; 430/58.8; 430/58.5

(57) ABSTRACT

The disclosed embodiments are directed to electrophotographic photoreceptors imaging members. More particularly, the imaging members of this disclosure comprise a charge transport layer comprising a charge transport molecule and a charge stabilizing compound to suppress the effects of corona effluents and provide stabilized charge acceptance during prolonged cycling, thereby improving print quality.

### BACKGROUND

Embodiments herein relate generally to electrophotographic photoreceptors imaging members. More particularly, the imaging members of this disclosure comprise a charge transport layer comprising a charge transport molecule and a charge stabilizing compound.

Electrophotographic imaging members, such as photoreceptors or photoconductors, typically include a photoconductive layer formed on an electrically conductive substrate or formed on layers between the substrate and photoconductive layer. The photoconductive layer is an insulator in the dark, so that during machine imaging processes, electric charges are retained on its surface. Upon exposure to light, the charge is dissipated, and an image can be formed thereon, developed using a developer material, transferred to a copy substrate, and fused thereto to form a copy or print.

The electrophotographic printing process, therefore, comprises a series of steps wherein the photoconductor surface is charged and discharged as printing takes place. It is important to keep the charge voltage and discharge voltage on the surface of the photoconductor constant as different pages are printed in order to make sure that the quality of the images produced are uniform (cycling stability). If the charge/discharge voltages change each time the drum/belt is cycled, e.g., if there is fatigue in the photoconductor surface, the quality of the pages printed will not be uniform and will be unsatisfactory.

Typically, under normal machine service conditions, the charge transport layer is constantly exposed to corona effluents (emitted from a charging device) and other volatile organic compound (VOC) species/contaminants. Exposure to corona effluents and chemical contaminants gives rise to charge transport layer material degradation and lateral charge migration (LCM) problems. Prolonged exposure to corona effluents causes an unwanted drop in charge acceptance, and thus leads to a darkening of the print background and susceptibility to ghosting effects. One method to resolve the unwanted drop in charge acceptance is to dynamically adjust the grid bias on the print engine to compensate for the drop in charge acceptance; however, this method is both difficult to implement and expensive. Thus, there exists a need to minimize the charge acceptance reduction of the photoreceptor itself, without any dynamic bias compensation, and without affecting the discharge performance of the charge transport molecule.

Conventional photoreceptors and their materials are disclosed in Katayama et al., U.S. Pat. No. 5,489,496; Yashiki, U.S. Pat. No. 4,579,801; Yashiki, U.S. Pat. No. 4,518,669; Seki et al., U.S. Pat. No. 4,775,605; Kawahara, U.S. Pat. No.5,656,407; Markovics et al., U.S. Pat. No. 5,641,599; Monbaliu et al., U.S. Pat. No. 5,344,734; Terrell et al., U.S. Pat. No.5,721,080; and Yoshihara, U.S. Pat. No. 5,017,449, which are herein all incorporated by reference.

More recent photoreceptors are disclosed in Fuller et al., U.S. Pat. No. 6,200,716; Maty et al., U.S. Pat. No. 6,180,309; and Dinh et al., U.S. Pat. No. 6,207,334, which are all herein incorporated by reference.

The terms “charge blocking layer”, “hole blocking layer” and “blocking layer” are generally used interchangeably with the phrase “undercoat layer.” The terms “charge generation layer,” “charge generating layer,” and “charge generator layer”) are generally used interchangeably with the phrase “photogenerating layer.” The terms “charge transport molecule” are generally used interchangeably with the terms “hole transport molecule.” The term “electrostatographic” includes “electrophotographic” and “xerographic.” The term “photoreceptor” or “photoconductor” is generally used interchangeably with the terms “imaging member.”

### SUMMARY

According to aspects illustrated herein, there is provided an imaging member comprising a substrate, a charge generation layer, and a charge transport layer disposed on the charge generation layer, wherein the charge transport layer comprises a charge transport molecule having a Formula I

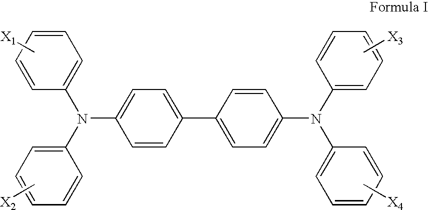

wherein each X₁, X₂, X₃ and X₄ is, independently, selected from alkyl, alkoxy, and halogen, and a charge stabilizing compound comprising an alkylated amine formaldehyde compound.

In one embodiment, the charge transport molecule is present in an amount of from about 1 percent weight to about 65 percent weight of the total weight of the charge transport layer.

In another embodiment, each X₁, X₂, X₃ and X₄ is alkyl. In a further embodiment, each X₁, X₂, X₃ and X₄ is alkyl. In still a further embodiment, each X₁, X₂, X₃ and X₄ is methyl.

In one embodiment, the alkylated amine formaldehyde is selected from methylated urea formaldehyde, butylated urea formaldehyde, methylated melamine formaldehyde and butylated melamine formaldehyde, and mixtures thereof. In a further embodiment, the alkylated amine formaldehyde is butylated melamine formaldehyde. In still a further embodiment, the alkylated amine formaldehyde is methoxymethyl butoxymethyl melamine formaldehyde. In one embodiment, the alkylated melamine formaldehyde has a Formula III:

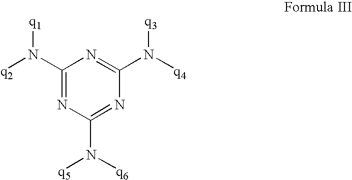

wherein each q₁, q₂, q₃, q₄, q₅ and q₆ is, independently, selected from hydrogen, alkyl, and alkoxyalkyl.

In one embodiment, the alkylated amine formaldehyde is present in an amount of from about 0.05 percent weight to about 10 percent weight of the total weight of the charge transport layer.

In certain embodiments, the imaging member further comprising a polymeric binder. In a further embodiment, the polymeric binder is present in an amount of from about 35 percent to about 95 percent weight of the total weight of the charge transport layer.

In one aspect, an imaging member includes a substrate, a charge generation layer, and at least one charge transport layer disposed on the charge generation layer, wherein the at least one charge transport layer comprises N,N,N′,N′-tetra(4-methylphenyl)-(1,1′-biphenyl)-4,4′-diamine, and a butylated melamine formaldehyde compound.

In one embodiment, the concentration of N,N,N′N′-tetra(4-methylphenyl)-(1,1′-biphenyl)-4,4′-diamine is from about 3 percent weight to about 10 percent weight of the total weight of the charge transport layer.

In another embodiment, the concentration of the butylated melamine formaldehyde compound is from about 0.5 percent weight to about 5 percent weight of the total weight of the charge transport layer.

Embodiments herein also provide an image forming apparatus for forming images on a recording medium comprising: a) an imaging member having a charge retentive-surface for receiving an electrophotographic latent image thereon, wherein the imaging member comprises a substrate, a charge generation layer, a charge transport layer disposed on the charge generation layer, wherein the charge transport layer comprises a charge transport molecule having a Formula I

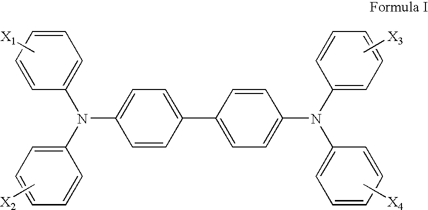

wherein each X₁, X₂, X₃ and X₄ is, independently, selected from alkyl, alkoxy, and halogen, and a charge stabilizing compound comprising an alkylated amine formaldehyde compound; b) a development component for applying a developer material to the charge-retentive surface to develop the electrophotographic latent image to form a developed image on the charge-retentive surface; c) a transfer component for transferring the developed image from the charge-retentive surface to a copy substrate; and d) a fusing component for fusing the developed image to the copy substrate. In one embodiment, each X₁, X₂, X₃ and X₄ is alkyl. In a further embodiment, each X₁, X₂, X₃ and X₄ is methyl. In another embodiment, the alkylated amine formaldehyde is selected from methylated urea formaldehyde, butylated urea formaldehyde, methylated melamine formaldehyde, butylated melamine formaldehyde, methylated benzoguanamine formaldehyde, butylated benzoguanamine formaldehyde, methylated glucoluril, and mixtures thereof. In a further embodiment, the alkylated amine formaldehyde is present in an amount of from about 0.05 percent to about 10 percent weight of the total weight of the charge transport layer.

In one embodiment, the image forming apparatus include a charge transport molecule that is present in an amount of from about 1 percent weight to about 65 percent weight of the total weight of the charge transport layer. In one embodiment, the charge transport layer further includes a polymeric binder and wherein the polymeric binder is present in an amount of from about 35 percent to about 95 percent weight of the total weight of the charge transport layer.

### BRIEF DESCRIPTION OF THE DRAWINGS

FIG. 1 illustrates an electrophotographic photoreceptor showing various layers in accordance with the present embodiments.

### DETAILED DESCRIPTION

In embodiments, by using specific charge transport layer compositions, provides stabilized charge acceptance during prolonged cycling and therefore improve print quality. Embodiments herein utilize a charge transport molecule together with a charge stabilizing compound in the charge transport layer to suppress the effects of corona effluents and to provide these improved results.

In the following description, reference is made to the accompanying drawings, which form a part hereof and which illustrate several embodiments. It is understood that other embodiments may be utilized and structural and operational changes may be made without departure from the scope of the present disclosure. The same reference numerals are used to identify the same structure in different figures unless specified otherwise. The structures in the figures are not drawn according to their relative proportions and the drawings should not be interpreted as limiting the disclosure in size, relative size, or location.

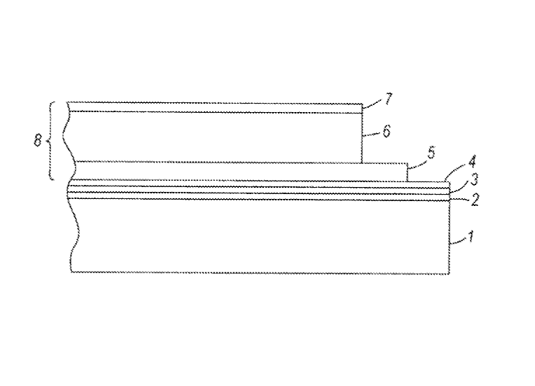

FIG. 1 illustrates a typical electrophotographic photoreceptor showing various layers. Multilayered electrophotographic photoreceptors or imaging members can have at least two layers, and may include a substrate, a conductive layer, an undercoat layer, an optional adhesive layer, a photogenerating layer, a charge transport layer, an optional overcoat layer and, in some embodiments, an anticurl backing layer. In the multilayer configuration, the active layers of the photoreceptor are the charge generation layer (CGL) and the charge transport layer (CTL). Enhancement of charge transport across these layers provides better photoreceptor performance. Overcoat layers are commonly included to increase mechanical wear and scratch resistance.

An imaging member may be provided in a number of forms. For example, the imaging member may be a homogeneous layer of a single material or it may be a composite layer containing a photoconductor and another material. In addition, the imaging member may be layered. These layers can be in any order, and sometimes can be combined in a single or mixed layer. The undercoating layer is generally located between the substrate and the imaging layer, although additional layers may be present and located between these layers. The imaging member may also include a charge generating layer and a charge transport layer.

The Substrate

Typically, a flexible or rigid substrate 1 is provided with an optional electrically conductive surface or coating 2. The substrate may be opaque or substantially transparent and may comprise any suitable material having the required mechanical properties. Accordingly, the substrate may comprise a layer of an electrically non-conductive or conductive material such as an inorganic or an organic composition. As electrically non-conducting materials, there may be employed various resins known for this purpose including polyesters, polycarbonates, polyamides, polyurethanes, and the like which are flexible as thin webs. Any suitable electrically conductive material can be employed, such as for example, metal or metal alloy. Electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, niobium, stainless steel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be single metallic compound or dual layers of different metals and/or oxides.

The substrate 1 can also be formulated entirely of an electrically conductive material, or it can be an insulating material including inorganic or organic polymeric materials, such as MYLAR, a commercially available biaxially oriented polyethylene terephthalate from DuPont, or polyethylene naphthalate available as KALEDEX 2000, with a ground plane layer 2 comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support substrate depends on numerous factors, including mechanical performance and economic considerations.

The substrate 1 may have a number of many different configurations, such as for example, a plate, a cylinder, a drum, a scroll, an endless flexible belt, and the like. In the case of the substrate being in the form of a belt, the belt can be seamed or seamless.

The thickness of the substrate depends on numerous factors, including flexibility, mechanical performance, and economic considerations. The thickness of the support substrate of the present embodiments may be at least about 500 microns, or no more than about 3,000 microns, or be at least about 750 microns, or no more than about 2500 microns.

An exemplary substrate support is not soluble in any of the solvents used in each coating layer solution, is optically transparent or semi-transparent, and is thermally stable up to a high temperature of about 150° C. A substrate support used for imaging member fabrication may have a thermal contraction coefficient ranging from about 1×10⁻⁵ per ° C. to about 3×10⁻⁵ per ° C. and a Young's Modulus of between about 5×10⁻⁵ psi (3.5×10⁻⁴ Kg/cm²) and about 7×10⁻⁵ psi (4.9×10⁻⁴ Kg/cm²).

The Ground Plane

In embodiments where the substrate layer is not conductive, the surface thereof may be rendered electrically conductive by an electrically conductive ground plane/coating 2. The conductive coating may vary in thickness over substantially wide ranges depending upon the optical transparency, degree of flexibility desired, and economic factors.

The electrically conductive ground plane 2 may be an electrically conductive metal layer which may be formed, for example, on the substrate by any suitable coating technique, such as a vacuum depositing technique. Metals include aluminum, zirconium, niobium, tantalum, vanadium, hafnium, titanium, nickel, stainless steel, chromium, tungsten, molybdenum, and other conductive substances, and mixtures thereof. The conductive layer may vary in thickness over substantially wide ranges depending on the optical transparency and flexibility desired for the electrophotoconductive member. Accordingly, for a flexible photoresponsive imaging device, the thickness of the conductive layer may be at least about 20 Angstroms, or no more than about 750 Angstroms, or at least about 50 Angstroms, or no more than about 200 Angstroms for an optimum combination of electrical conductivity, flexibility and light transmission.

Regardless of the technique employed to form the metal layer, a thin layer of metal oxide forms on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as transparent layer for light having a wavelength between about 4000 Angstroms and about 9000 Angstroms or a conductive carbon black dispersed in a polymeric binder as an opaque conductive layer.

The Hole Blocking Layer

After deposition of an electrically conductive ground plane layer, a hole blocking layer, or an undercoat layer 3 may be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer may be utilized. The hole blocking layer may include polymers such as polyvinylbutryral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl)gamma-amino-propyl trimethoxy silane, isopropyl 4-aminobenzene sulfonyl, di(dodecylbenzene sulfonyl)titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl)methyl diethoxysilane, and [H₂N(CH₂)₃]CH₃Si(OCH₃)₂ (gamma-aminopropyl)methyl diethoxysilane, as disclosed in U.S. Pat. Nos. 4,338,387, 4,286,033 and 4,291,110.

General embodiments of the undercoat layer 3 may comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Undercoat layer binder materials may include, for example, polyesters, MOR-ESTER 49,000 from Morton International Inc., VITEL PE-100, VITEL PE-200, VITEL PE-200D, and VITEL PE-222 from Goodyear Tire and Rubber Co., polyarylates such as ARDEL from AMOCO Production Products, polysulfone from AMOCO Production Products, polyurethanes, and the like.

The hole blocking layer 3 should be continuous. The thickness of the hole blocking layers in belt photoreceptors are normally less than about 0.5 microns because greater thicknesses may lead to undesirably high residual voltage. However, in drum based photoreceptors the hole blocking layer can have a thickness of up to 30 microns. A hole blocking layer of between about 0.005 microns and about 0.3 microns is used because charge neutralization after the exposure step is facilitated and optimum electrical performance is achieved. A thickness of between about 0.03 microns and about 0.06 microns is used for hole blocking layers for optimum electrical behavior. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer is applied in the form of a dilute solution, with the solvent being removed after deposition of the coating by conventional techniques such as by vacuum, heating and the like. Generally, a weight ratio of hole blocking layer material and solvent of between about 0.05:100 to about 0.5:100 is satisfactory for spray coating.

The Adhesive Layer

An optional separate adhesive interfacial layer 4 may be provided in certain configurations, such as for example, in flexible web configurations. In the embodiment illustrated in FIG. 1, the interfacial layer would be situated between the blocking layer 3 and the charge generation layer 5. The interfacial layer may include a copolyester resin. Exemplary polyester resins which may be utilized for the interfacial layer include polyarylatepolyvinylbutyrals, such as ARDEL POLYARYLATE (U-100) commercially available from Toyota Hsutsu Inc., VITEL PE-100, VITEL PE-200, VITEL PE-200D, and VITEL PE-222, all from Bostik, 49,000 polyester from Rohm Hass, polyvinyl butyral, and the like. The adhesive interfacial layer may be applied directly to the hole blocking layer 3. Thus, the adhesive interfacial layer in embodiments is in direct contiguous contact with both the underlying hole blocking layer 3 and the overlying charge generation layer 5 to enhance adhesion bonding to provide linkage. In yet other embodiments, the adhesive interfacial layer is entirely omitted.

Any suitable solvent or solvent mixtures may be employed to form a coating solution of the polyester for the adhesive interfacial layer. Solvents may include tetrahydrofuran, toluene, monochlorbenzene, methylene chloride, cyclohexanone, and the like, and mixtures thereof. Any other suitable and conventional technique may be used to mix and thereafter apply the adhesive layer coating mixture to the hole blocking layer. Application techniques may include spraying, dip coating, roll coating, wire wound rod coating, and the like. Drying of the deposited wet coating may be effected by any suitable conventional process, such as oven drying, infra red radiation drying, air drying, and the like.

The adhesive interfacial layer may have a thickness of at least about 0.01 microns, or no more than about 900 microns after drying. In embodiments, the dried thickness is from about 0.03 microns to about 1 micron.

The Imaging Layer

At least one imaging layer 8 is formed on the adhesive layer 4 or the undercoat layer 3. The imaging layer 8 may be a single layer that performs both charge-generating and charge transport functions as is well known in the art, or it may comprise multiple layers such as a charge generating layer 5, a charge transport layer 6, and an optional overcoat layer 7.

The Charge Generation Layer

The charge generation layer 5 may thereafter be applied to the undercoat layer 3. Any suitable charge generation binder including a charge generating/photoconductive material, which may be in the form of particles and dispersed in a film forming binder, such as an inactive resin, may be utilized. Examples of charge generating materials include, for example, inorganic photoconductive materials such as amorphous selenium, trigonal selenium, and selenium alloys selected from selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions may be used where a photoconductive layer enhances or reduces the properties of the charge generation layer. Other suitable charge generating materials known in the art may also be utilized, if desired. The charge generating materials selected should be sensitive to activating radiation having a wavelength between about 400 and about 900 nm during the imagewise radiation exposure step in an electrophotographic imaging process to form an electrophotographic latent image. For example, hydroxygallium phthalocyanine absorbs light of a wavelength of from about 370 to about 950 nanometers, as disclosed, for example, in U.S. Pat. No.5,756,245.

A number of titanyl phthalocyanines, or oxytitanium phthalocyanines for the photoconductors illustrated herein are photogenerating pigments known to absorb near infrared light around 800 nanometers, and may exhibit improved sensitivity compared to other pigments, such as, for example, hydroxygallium phthalocyanine. Generally, titanyl phthalocyanine is known to have five main crystal forms known as Types I, II, III, X, and IV. For example, U.S. Pat. Nos. 5,189,155 and 5,189,156, the disclosures of which are totally incorporated herein by reference, disclose a number of methods for obtaining various polymorphs of titanyl phthalocyanine. Additionally, U.S. Pat. Nos. 5,189,155 and 5,189,156 are directed to processes for obtaining Types I, X, and IV phthalocyanines. U.S. Pat. No. 5,153,094, the disclosure of which is totally incorporated herein by reference, relates to the preparation of titanyl phthalocyanine polymorphs including Types I, II, III, and IV polymorphs. U.S. Pat. No. 5,166,339, the disclosure of which is totally incorporated herein by reference, discloses processes for preparing Types I, IV, and X titanyl phthalocyanine polymorphs, as well as the preparation of two polymorphs designated as Type Z-1 and Type Z-2.

Any suitable inactive resin materials may be employed as a binder in the charge generation layer 5, including those described, for example, in U.S. Pat. No. 3,121,006, the entire disclosure thereof being incorporated herein by reference. Organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

The charge generating material can be present in the resinous binder composition in various amounts. Generally, at least about 5 percent by volume, or no more than about 90 percent by volume of the charge generating material is dispersed in at least about 95 percent by volume, or no more than about 10 percent by volume of the resinous binder, and more specifically at least about 20 percent, or no more than about 60 percent by volume of the charge generating material is dispersed in at least about 80 percent by volume, or no more than about 40 percent by volume of the resinous binder composition.

In specific embodiments, the charge generation layer 5 may have a thickness of at least about 0.1 μm, or no more than about 2 μm, or of at least about 0.2 μm, or no more than about 1 μm. These embodiments may be comprised of chlorogallium phthalocyanine or hydroxygallium phthalocyanine or mixtures thereof. The charge generation layer 5 containing the charge generating material and the resinous binder material generally ranges in thickness of at least about 0.1 μm, or no more than about 5 μm, for example, from about 0.2 μm to about 3 μm when dry. The charge generation layer thickness is generally related to binder content. Higher binder content compositions generally employ thicker layers for charge generation.

The Charge Transport Layer

The charge transport layer 6 is thereafter applied over the charge generation layer 5 and may include any suitable transparent organic polymer or non-polymeric material capable of supporting the injection of photogenerated holes or electrons from the charge generation layer 5 and capable of allowing the transport of these holestelectrons through the charge transport layer to selectively discharge the surface charge on the imaging member surface. In one embodiment, the charge transport layer 6 not only serves to transport holes, but also protects the charge generation layer 5 from abrasion or chemical attack and may therefore extend the service life of the imaging member. The charge transport layer 6 can be a substantially non-photoconductive material, but one which supports the injection of photogenerated holes from the charge generation layer 5.

The charge transport layer 6 is normally transparent in a wavelength region in which the electrophotographic imaging member is to be used when exposure is affected there to ensure that most of the incident radiation is utilized by the underlying charge generation layer 5. The charge transport layer should exhibit excellent optical transparency with negligible light absorption and no charge generation when exposed to a wavelength of light useful in xerography, e.g., 400 to 900 nanometers. In the case when the photoreceptor is prepared with the use of a transparent substrate 1 and also a transparent or partially transparent conductive layer 2, image wise exposure or erase may be accomplished through the substrate 1 with all light passing through the back side of the substrate. In this case, the materials of the charge transport layer 6 need not transmit light in the wavelength region of use if the charge generation layer 5 is sandwiched between the substrate and the charge transport layer 6. The charge transport layer 6 in conjunction with the charge generation layer 5 is an insulator to the extent that an electrophotographic charge placed on the charge transport layer is not conducted in the absence of illumination. The charge transport layer 6 should trap minimal charges as the charge passes through it during the discharging process.

The charge transport layer 6 may include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes through. This addition converts the electrically inactive polymeric material to a material capable of supporting the injection of photogenerated holes from the charge generation layer 5 and capable of allowing the transport of these holes through the charge transport layer 6 in order to discharge the surface charge on the charge transport layer. The high mobility charge transport component may comprise small molecules of an organic compound which cooperate to transport charge between molecules and ultimately to the surface of the charge transport layer.

A charge transport layer may comprise more than one layers. For example, the charge transport layer may comprise a first charge transport layer, a second charge transport layer, and so on. Typically, a first charge transport layer is disposed onto the layer below the charge transport layer, e.g. a charge generating layer, and a second charge transport layer is disposed onto a first charge transport layer. Therefore, a first charge transport layer may be referred to as a bottom layer.

The charge transport layer or layers, and more specifically, a first charge transport layer in contact with a charge generating layer, and thereover a top or second charge transport layer may comprise a charge transport molecule dissolved or molecularly dispersed in a film forming electrically inert polymer such as a polycarbonate. In embodiments, “dissolved” refers, for example, to forming a solution in which the charge transport molecule is dissolved in the polymer to form a homogeneous phase. Various charge transport molecules may be selected for the charge transport layer or layers. In embodiments, charge transport refers, for example, to charge transport molecules as a monomer that allows the free charge generated in the charge generating layer to be transported across the transport layer.

Each charge transport layer, independently, may comprise a charge transport molecule. Examples of charge transport molecule, especially for the first and/or second charge transport layers, include, for example, pyrazolines such as 1-phenyl-3-(4′-diethylamino styryl)-5-(4″-diethylamino phenyl)pyrazoline; aryl amines (discussed in detail below); hydrazones such as N-phenyl-N-methyl-3-(9-ethyl)carbazyl hydrazone and 4-diethyl amino benzaldehyde-1,1-diphenyl hydrazone; and oxadiazoles such as 2,5-bis(4-N,N′-diethylaminophenyl)-1 3,4-oxadiazole, stilbenes, and the like.

In embodiments, a charge transport molecules is an aryl amine of the following formulas:

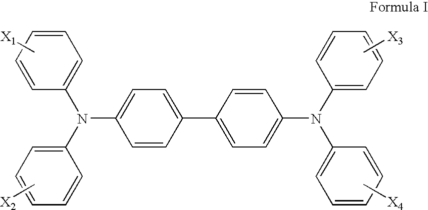

wherein each X₁, X₂, X₃ and X₄ is, independently, selected from alkyl, alkoxy, aryl, and halogen; and

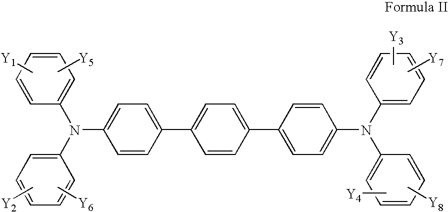

wherein each Y₁, Y₂, Y3, Y₄, Y₅, Y₆, Y₇ and Y₈ is, independently, selected from hydrogen, alkyl, alkoxy, aryl, and halogen.

Non-limiting examples of specific aryl amines include N,N′-diphenyl-N,N′-bis(3-methylphenyl)-(1,1′-biphenyl)-4,4′-diamine, N,N′-bis(4-butylphenyl)-N,N′-di-p-tolyl-[p-terphenyl]-4,4″-diamine, N,N′-bis(4-butylphenyl)-N,N′-di-m-tolyl-[p-terphenyl]-4,4″-diamine, N,N′-bis(4-butylphenyl)-N,N′-di-o-tolyl-[p-terphenyl]-4,4″-diamine, N,N′-bis(4-butylphenyl)-N,N′-bis-(4-isopropylphenyl)-[p-terphenyl]-4,4″-diamine, N,N′-bis(4-butylphenyl)-N,N′-bis-(2-ethyl-6-methylphenyl)-[p-terp-henyl]-4,4″-diamine, N,N′-bis(4-butylphenyl)-N,N′-bis-(2,5-dimethylphenyl)-[p-terphenyl]-4,4″-diamine, N,N′-diphenyl-N,N′-bis(3-chlorophenyl)-[p-terphenyl]-4,4″-diamine, N,N,N′N′-tetra(4-methylphenyl)-(1,1′-biphenyl)-4,4′-diamine, N,N,N′N′-tetra(4-ethylphenyl)-(1,1′-biphenyl)-4,4′-diamine, N,N,N′N′-tetra(4-propylphenyl)-(1,1′-biphenyl)-4,4′-diamine, N,N,N′N′-tetra(4-butylphenyl)-(1,1′-biphenyl)-4,4′-diamine and the like. Other known charge transport layer molecules can be selected, reference for example, U.S. Pat. Nos. 4,921,773 and 4,464,450, the disclosures of which are totally incorporated herein by reference.

In certain embodiments, the charge transport molecule is an aryl amine, such as, N,N,N′,N′-tetra(4-methylphenyl)-(1,1′-biphenyl)-4,4′-diamine, such that, when the charge transport molecule disclosed herein is incorporated into a photoreceptor, the photoreceptor will exhibit an improved rate of discharge of its surface potential as well as improved cycling stability. As used herein, the term “cycling stability” refers to lack of change in electrical characteristics during electrophotographic cycling. Improving discharge rate is advantageous because high speed printing applications require a shorter expose to development time within which the photoreceptor must discharge its surface potential. Therefore, photoreceptors exhibiting an improved discharge rate are important in high speed printing applications and the like, and may reduce the overall costs associated with large-scale or commercial printing operations.

More specifically, the charge transport molecule is a substituted biphenyl diamine of high quality. As used herein, “high quality” referring to the substituted biphenyl diamine thus refers to a substituted biphenyl diamine that have a purity of from about 95 percent to about 100 percent, such as from about 98 percent to about 100 percent, as determined for example, by HPLC, NMR, GC, LC/MS, GC/MS or by melting temperature data. Although not limited to any specific theory, it is believed that the high quality of the substituted biphenyl diamine, and the properties provided thereby, may not be directly linked to its chemical purity alone, but instead may be linked to the chemical purity, type and amount of residual impurities, and the like. In embodiments, a photoreceptor having incorporated a substituted biphenyl diamine of high quality charge transport molecule may discharge from about 85% to about 100% of its surface potential in from about 0 to about 40 milliseconds upon being subjected to xerographic charging and exposure to radiant energy of from about 1 erg/cm² to about 5 ergs/cm², such as from about 85% to about 100% of its surface potential in from about 0 to about 40 milliseconds of being subjected to xerographic charging and exposure to radiant energy of about 1 erg/cm² to about 4 ergs/cm². In embodiments, a photoreceptor comprising an aryl amine may have a post erase voltage of from about 0 to about 10 volts, from an initial charging voltage of from about 400 to about 1000 volts, when erase energy is about 200 ergs/cm². The aryl amine may also exhibit stable xerographic cycling over 10,000 cycles. The discharge may reduced to less than 85% under the same conditions as stated above with a photoreceptor having incorporated a non-high-quality charge transport molecule.

In embodiments, at least one charge transport layer is comprised of at least one charge transport molecule described herein. In embodiments the concentration of the charge transport molecule in the charge transport layer may be in the range of from about 1 weight percent to about 65 weight percent, and more specifically from about 3 weight percent to about 40 weight percent, or from about 3 weight percent to about 10 weight percent.

Examples of the highly insulating and transparent resinous components or inactive binder resinous material for the transport layers include materials such as those described in U.S. Pat. No. 3,121,006, the disclosure of which is totally incorporated herein by reference. Specific examples of suitable organic resinous materials include polycarbonates, such as MAKROLON 5705 from Farbenfabriken Bayer AG or FPC0170 from Mitsubishi Gas Chemical Co., acrylate polymers, vinyl polymers, cellulose polymers, polyesters, polysiloxanes, polyamides, polyurethanes, polystyrenes, polyarylates, polyethers, polysulfones, and epoxies, as well as block, random or alternating copolymers thereof. Specific examples include polycarbonates such as poly(4,4′-isopropylidene-diphenylene)carbonate (also referred to as bisphenol-A-polycarbonate, poly(4,4′-cyclohexylidinediphenylene)carbonate (referred to as bisphenol-Z polycarbonate), poly(4,4′-isopropylidene-3,3′-imethyl-diphenyl)carbonate (also referred to as bisphenol-C-polycarbonate), and the like. Specific examples of electrically inactive binder materials include polycarbonate resins having a number average molecular weight of from about 20,000 to about 150,000 with a molecular weight in the range of from about 50,000 to about 100,000 being particularly preferred. Any suitable charge transporting polymer can also be used in the charge transporting layer.

The charge transport layer should be an insulator to the extent that the electrophotographic charge placed on the hole transport layer is not conducted in the absence of illumination at a rate sufficient to prevent formation and retention of an electrophotographic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used.

Drying of the deposited coating may be effected by any suitable conventional technique such as oven drying, infra red radiation drying, air drying and the like. The thickness of the charge transport layer after drying is from about 10 μm to about 40 μm or from about 12 μm to about 36 μm for optimum photoelectrical and mechanical results. In another embodiment the thickness is from about 14 μm to about 36 μm.

A polymeric binder may be present in the amount from about 35 weight percent to about 95 weight percent, from about 70 weight percent to about 90 weight percent, or from about 80 weight percent to about 90 weight percent of the charge transport layer.

In embodiments, a charge transport layer may comprise an alkylated amine formaldehyde compound or resin. Non-limiting examples of alkylated amine formaldehyde compounds include methylated urea formaldehyde compounds, butylated urea formaldehyde compounds, methylated melamine formaldehyde compounds, butylated melamine formaldehyde compounds, methylated benzoguanamine formaldehyde compounds, butylated benzoguanamine formaldehyde compounds, methylated glucoluril compounds and mixtures thereof.

Commercially available alkylated amine formaldehyde compounds include, but not limited to, CYMEL® 303, which is a methoxymethylated melamine formaldehyde compound and has the following structure:

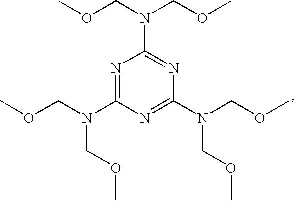

CYMEL® 1130, which is a methoxymethyl butoxymethyl melamine formaldehyde compound, CYMEL® 1123, which is a methoxymethyl ethoxymethyl benzoguanamine compound, and CYMEL® 659 which is a butylated benzoguanamine formaldehyde compound. All of the CYMEL® compounds are manufactured by Cytec Industries Inc.

In embodiments, a charge stabilizing compound is an alkylated amine formaldehyde of Formula III:

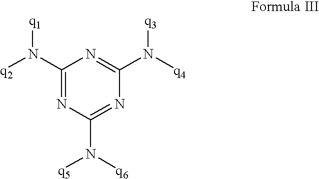

wherein each q₁, q₂, q₃, q₄, q₅ and q₆ is, independently, selected from hydrogen, alkyl, and alkoxyalkyl. In one embodiment, at least one of q₁, q₂, q₃, q₄, q₅ and q₆ is an alkoxylalkyl. In a further embodiment, at least one of q₁, q₂, q₃, q₄, q₅ and q₆ has the formula —(CH₂)ₙ—O—(CH₂)ₘCH₃, wherein n is from 1 to 20 and m is from 1 to 20. In still a further embodiment, at least one of q₁, q₂, q₃, q₄, q₅ and q₆ has the formula —(CH₂)ₙ—O—(CH₂)ₘCH₃, wherein n is 1 and m is from 0 to 3. In one embodiment, at least one of q₁, q₂, q₃, q₄, q₅ and q₆ has the formula —(CH₂)—O— CH₃ and at least one of q₁, q₂, q₃, q₄, q₅ and q₆ has the formula —(CH₂)—O—(CH₂)₃CH₃.

A charge transport layer may contain from about 0% to about 10% by weight of the charge stabilizing compound. In one embodiment, a charge transport layer may contain from about 0 percent weight to about 10 percent weight, or from about 0.5 percent weight to about 5 percent weight alkylated amine formaldehyde in the charge transport layer.

The term “alkyl,” as used herein, alone or in combination, refers to a straight-chain or branched-chain alkyl radical containing from 1 to 25, and more specifically, from 1 to 12 carbon atoms. Alkyl groups may be optionally substituted as defined herein. Examples of alkyl radicals include methyl, ethyl, n-propyl, isopropyl, n-butyl, isobutyl, sec-butyl, tert-butyl, pentyl, iso-amyl, hexyl, octyl, noyl and the like.

The term “alkoxy,” as used herein, alone or in combination, refers to an alkyl ether radical, wherein the term alkyl is as defined herein. Examples of suitable alkyl ether radicals include methoxy, ethoxy, n-propoxy, isopropoxy, n-butoxy, iso-butoxy, sec-butoxy, tert-butoxy, and the like.

The term “alkoxyalkyl,” as used herein, alone or in combination, refers to an alkoxy group appended to a loweralkyl radical, or an alkoxy group attached to the parent molecular moiety through an alkyl group. The term “alkoxyalkyl” also embraces alkoxyalkyl groups having one or more alkoxy groups attached to the alkyl group, that is, to form monoalkoxyalkyl and dialkoxyalkyl groups. Non-limiting example of alkoxyalkyl groups is —(CH₂)ₙ—O—(CH₂)ₘCH₃, wherein n is from 1 to 20 and m is from 1 to 20.

The term “aryl,” as used herein, alone or in combination, means a carbocyclic aromatic system containing one, two or three rings wherein such rings may be attached together in a pendent manner or may be fused. The term “aryl” embraces aromatic radicals such as benzyl, phenyl, naphthyl, anthracenyl, phenanthryl, indanyl, indenyl, annulenyl, azulenyl, tetrahydronaphthyl, biphenyl, and the like.

The term “halogen,” as used herein, refers to chloride, bromide, iodide, and fluoride.

Without being bound by theory, it is believed that during exposure to corona effluents of the phororeceptor, the addition of a charge stabilizing compound, such as, an alkylated amine formaldehyde compound, in the charge transport layer may suppress the charge acceptance (Vh) drop exhibited by using a charge transport molecule disclosed herein.

Examples of components or materials optionally incorporated into the charge transport layers, or at least one charge transport layer or the overcoating layer to, for example, enable improved lateral charge migration (LCM) resistance include hindered phenolic antioxidants, such as tetrakis methylene(3,5-di-tert-butyl-4-hydroxy hydrocinnamate)methane (IRGANOX.™. 1010, available from Ciba Specialty Chemical), 2,2′-Methylenebis(4-ethyl-6-tert-butylphenol) (Cyanox 425) (available from Cytec Industries Inc., West Paterson, N.J.) butylated hydroxytoluene (BHT), and other hindered phenolic antioxidants including SUMILIZER.™. BHT-R, MDP-S, BBM-S, WX-R, NR, BP-76, BP-101, GA-80, GM and GS (available from Sumitomo Chemical Co., Ltd.), IRGANOX.™. 1035, 1076, 1098, 1135, 1141, 1222, 1330, 1425WL, 1520L, 245, 259, 3114, 3790, 5057 and 565 (available from Ciba Specialties Chemicals), and ADEKA STAB.™.0 AO-20, AO-30, AO-40, AO-50, AO-60, AO-70, AO-80 and AO-330 (available from Asahi Denka Co., Ltd.); hindered amine antioxidants such as SANOL.™.0 LS-2626, LS-765, LS-770 and LS-744 (available from SNKYO CO., Ltd.), TINUVIN.™. 144 and 622LD (available from Ciba Specialties Chemicals), MARK.™. LA57, LA67, LA62, LA68 and LA63 (available from Asahi Denka Co., Ltd.), and SUMILIZER.™.0 TPS (available from Sumitomo Chemical Co., Ltd.); thioether antioxidants such as SUMILIZER.™. TP-D (available from Sumitomo Chemical Co., Ltd); phosphite antioxidants such as MARK.™. 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), hydroquinone anti-oxidants (i.e. 2,5-di(tert-amyl)hydroquinone), and the like. The weight percent of the antioxidant in at least one of the charge transport layers is from about 0 weight percent to about 20 weight percent, from about 1 weight percent to about 10 weight percent or from about 3 weight percent to about 8 weight percent of the charge transport layer.

The charge transport layer should be an insulator to the extent that the electrophotographic charge placed on the hole transport layer is not conducted in the absence of illumination at a rate sufficient to prevent formation and retention of an electrophotographic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used.

A number of processes may be used to mix, and thereafter apply the charge transport layer or layers coating mixture to the photogenerating layer. Typical application techniques include spraying, dip coating, roll coating, wire wound rod coating, and the like. Drying of the charge transport deposited coating may be effected by any suitable conventional technique such as oven drying, infrared radiation drying, air drying, and the like.

Drying of the deposited coating may be effected by any suitable conventional technique such as oven drying, infra red radiation drying, air drying and the like. The thickness of each of the charge transport layers after drying in embodiments, is from about 2 microns to about 90 microns, and more specifically, of a thickness of from about 10 microns to about 40 microns, or from about 12 microns to about 36 microns for optimum photoelectrical and mechanical results. In another embodiment the thickness is from about 14 microns to about 36 microns. However, thickness outside of this range may in embodiments also be selected.

The Overcoat Layer

Other layers of the imaging member may include, for example, an optional over coat layer 7. An optional overcoat layer 7, if desired, may be disposed over the charge transport layer 6 to provide imaging member surface protection as well as improve resistance to abrasion. In embodiments, the overcoat layer 7 may have a thickness ranging from about 0.1 micron to about 10 microns or from about 1 micron to about 10 microns, or in a specific embodiment, about 3 microns. These overcoating layers may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene (PTFE), and combinations thereof. Suitable resins include those described above as suitable for photogenerating layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoating layers may be continuous and have a thickness of at least about 0.5 micron, or no more than 10 microns, and in further embodiments have a thickness of at least about 2 microns, or no more than 6 microns.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

The embodiments will be described in further detail with reference to the following examples and comparative examples. All the “parts” and “%” used herein mean parts by weight and % by weight unless otherwise specified.

The following Examples are being submitted to illustrate embodiments of the disclosure.

Purification of N,N,N′N′-tetra(4-methylphenyl)-(1,1′-biphenyl)-4,4′-diamine (Compound 1):
N,N,N′N′-tetra(4-methylphenyl)-(1,1′-biphenyl)-4,4′-diamine was purified with a purity of 98 to 100 percent using various methods: train sublimation, a Kaufmann column run with alumina and a non-polar solvent such as hexane, hexanes, cyclohexane, heptane and the like, absorbent treatments such as with the use of alumina, clay, charcoal and the like and recrystallization to produce the desired purity.

N,N,N′N′-tetra(4-methylphenyl)-(1,1′-biphenyl)-4,4′-diamine can be prepared through reactions such as a Buchwald-Hartwig reaction, or other reactions known to those skilled in the art. The purity of the final material may be instrumental in obtaining the improved electrical and mechanical properties.

### Example 1

### Comparative Example

An imaging member incorporating Compound 1 was prepared in accordance with the following procedure. A metallized mylar substrate was provided and a HOGaPc/poly(bisphenol-Z carbonate) photogenerating layer was machine coated over the substrate. The photogenerating layer was overcoated with a first layer (bottom layer) charge transport layer prepared by introducing into an amber glass bottle 55 weight percent of high quality N,N,N′N′-tetra(4-methylphenyl)-(1,1′-biphenyl)-4,4′-diamine (Compound 1), synthesized as discussed above, having a purity of from about 99 to about 100 percent as determined by HPLC and NMR and 45 weight percent of MAKROLON 5705®, a known polycarbonate resin having a molecular weight average of from about 50,000 to about 100,000, commercially available from Farbenfabriken Bayer A.G. The resulting mixture was then dissolved in methylene chloride to form a solution containing 15 percent by weight solids. This solution was applied on the photogenerating layer to form a layer coating that upon drying (120° C. for 1 minute) had a thickness of 15 microns. During this coating process, the humidity was equal to or less than about 15 percent. The first layer (bottom layer) charge transport layer was then overcoated with a second layer (top layer) charge transport layer by repeating the process of preparing and coating the first layer (bottom layer) charge transport layer except that the second layer (top layer) charge transport layer is prepared by introducing into an amber glass bottle 9.2 weight percent of high quality N,N,N′N′-tetra(4-methylphenyl)-(1,1′-biphenyl)-4,4′-diamine (Compound 1) and 84 weight percent of MAKROLON 5705® and 6.8 weight percent of 2,2′-Methylenebis(4-ethyl-6-tert-butylphenol) (Available from Cytec industries) (Compound 2). This solution was applied on top of the first layer (bottom layer) charge transport layer to form a layer coating that upon drying (120° C. for 1 minute) had a thickness of 15 microns. The combined total thickness of the two layer charge transport layers was 30 microns.

### Example 2

Imaging member example 2 was prepared by repeating the process of Example 1 except that, in example 2, the second layer (top layer) charge transport layer is prepared by introducing into an amber glass bottle 9.3 weight percent of high quality N,N,N′N′-tetra(4-methylphenyl)-(1,1′-biphenyl)-4,4′-diamine (Compound 1) and 83.4 weight percent of MAKROLON 5705® and 6.7 weight percent of 2,2′-Methylenebis(4-ethyl-6-tert-butylphenol) (Compound 2) and 0.6 weight percent of butylated melamine formaldehyde (CYMEL® 1130 available from Cytec Industries) (Compound 3). This solution was applied on top of the first layer (bottom layer) charge transport layer to form a layer coating that upon drying (120° C. for 1 minute) had a thickness of 15 microns. The combined total thickness of the two layer charge transport layers was 30 microns.

### Example 3

Imaging member example 3 was prepared by repeating the process of Example 1 except that, in example 3, the second layer (top layer) charge transport layer is prepared by introducing into an amber glass bottle 9.1 weight percent of high quality N,N,N′N′-tetra(4-methylphenyl)-(1,1′-biphenyl)-4,4′-diamine (Compound 1) and 82 weight percent of MAKROLON 5705® and 6.6 weight percent of 2,2′-Methylenebis(4-ethyl-6-tert-butylphenol) (Compound 2) and 2.3 weight percent of butylated melamine formaldehyde (CYMEL® 1130 available from Cytec Industries) (Compound 3). This solution was applied on top of the first layer (bottom layer) charge transport layer to form a layer coating that upon drying (120° C. for 1 minute) had a thickness of 15 microns. The combined total thickness of the two layer charge transport layers was 30 microns.

The imaging members in Examples 1-3 were evaluated on a flat plate scanner to measure the charge acceptance before long term corona exposure (Vhₒ) and discharge voltage (V_{L}) by measuring the surface potential before and after photo exposure during a xerographic cycle. A corotron wire at a potential of 4,750 volts was used to charge the surface of the imaging member and the surface potential was then measured using a capacitive probe to give a value of charge acceptance (Vhₒ). The imaging member was then exposed to 10 ergs/cm² of 780 nm light from a filtered Xenon lamp to discharge the surface potential. 500 milliseconds after exposure the surface potential of the imaging member was again measured using a capacitive probe to give a value of discharge voltage (V_{L}).

The imaging members in examples 1-3 were mounted onto a 84 mm bare aluminum drum using conductive copper tape to adhere the exposed conductive end of the devices to the exposed aluminum on the drum to complete a conductive path to the ground. The drum was placed in a charge-discharge apparatus that generated corona discharge during operation without any ventilation, thus causing very aggressive corona exposure. A multiplication factor was believed to be at least 10 times. The drum was charged and discharged (cycled) for 10,000 cycles. The imaging members in Examples 1-3 were then removed from the apparatus and evaluated on a flat plate scanner to measure the charge acceptance after long term corona exposure (Vhₒ) by measuring the surface potential before photo exposure during a xerographic cycle. A Corotron wire at a potential of 4,750 volts was used to charge the surface of the imaging member and the surface potential was then measured using a capacitive probe to give a value of charge acceptance (Vhₑ). The difference between Vhₒand Vhₑ is the change in charge acceptance (ΔVₕ) that occurs after 10,000 cycles in a charge-discharge apparatus that generates corona without ventilation.

For the imaging member prepared in Example 1, ΔVₕ was 320 Volts. The imaging member exhibited a relatively large change in charge acceptance when exposed to corona in an unventilated charge discharge apparatus for 10,000 cycles.

For the imaging member prepared in Example 2, ΔVₕ was 200 Volts. The imaging member exhibited significantly less change in charge acceptance when exposed to corona in an unventilated charge discharge apparatus for 10,000 cycles as compared to Example 1.

For the imaging member prepared in Example 3, ΔVₕ was 100 Volts. The imaging member exhibited significantly less change in charge acceptance when exposed to corona in an unventilated charge discharge apparatus for 10,000 cycles as compared to Example 1.

The above data is summarized in the table below:

| | | | ΔVh (Vhₒ − | V_{L} (Volts) at |
|---|---|---|---|---|
| | Vhₒ (Volts) | Vhₑ (Volts) | Vhₑ)(Volts) | 10 erg/cm² |
| Example 1 | 960 | 640 | 320 | 25 |
| Example 2 | 920 | 720 | 200 | 27 |
| Example 3 | 840 | 740 | 100 | 25 |

All the patents and applications referred to herein are hereby specifically, and totally incorporated herein by reference in their entirety in the instant specification.

It will be appreciated that various of the above-disclosed and other features and functions, or alternatives thereof, may be desirably combined into many other different applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An imaging member comprising:
a substrate;
a charge generation layer;
a charge transport layer disposed on the charge generation layer, wherein the charge transport layer comprises a charge transport molecule having a Formula I 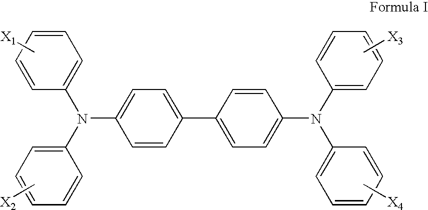
wherein each X₁, X₂, X₃ and X₄ is, independently, selected from alkyl, alkoxy, and halogen; and
a charge stabilizing compound comprising an alkylated amine formaldehyde compound.

2. The imaging member of claim 1, wherein the charge transport molecule is present in an amount of from about 1 percent weight to about 65 percent weight of the total weight of the charge transport layer.

3. The imaging member of claim 1, wherein each X₁, X₂, X₃ and X₄ is alkyl.

4. The imaging member of claim 1, wherein each X₁, X₂, X₃ and X₄ is methyl.

5. The imaging member of claim 1, wherein the alkylated amine formaldehyde is selected from methylated urea formaldehyde, butylated urea formaldehyde, methylated melamine formaldehyde and butylated melamine formaldehyde, and mixtures thereof.

6. The imaging member of claim 1, wherein the alkylated amine formaldehyde is butylated melamine formaldehyde.

7. The imaging member of claim 1, wherein the alkylated amine formaldehyde is methoxymethyl butoxymethyl melamine formaldehyde.

8. The imaging member of claim 1, wherein the alkylated melamine formaldehyde has a Formula III: 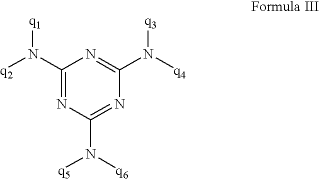
wherein each q₁, q₂, q₃, q₄, q₅ and q₆ is, independently, selected from hydrogen, alkyl, and alkoxyalkyl.

9. The imaging member of claim 1, wherein the alkylated amine formaldehyde is present in an amount of from about 0.05 percent weight to about 10 percent weight of the total weight of the charge transport layer.

10. The imaging member of claim 1, further comprising a polymeric binder.

11. The imaging member of claim 10, wherein the polymeric binder is present in an amount of from about 35 percent to about 95 percent weight of the total weight of the charge transport layer.

12. An imaging member comprising:
a substrate;
a charge generation layer; and
at least one charge transport layer disposed on the charge generation layer, wherein the at least one charge transport layer comprises N,N,N′,N′-tetra(4-methylphenyl)-(1,1′-biphenyl)-4,4′-diamine, and a butylated melamine formaldehyde compound.

13. The imaging member of claim 12, wherein the concentration of N,N,N′N′-tetra(4-methylphenyl)-(1,1′-biphenyl)-4,4′-diamine is from about 3 percent weight to about 10 percent weight of the total weight of the charge transport layer.

14. The imaging member of claim 12, wherein the concentration of the butylated melamine formaldehyde compound is from about 0.5 percent weight to about 5 percent weight of the total weight of the charge transport layer.

15. An image forming apparatus for forming images on a recording medium comprising:
a) an imaging member having a charge retentive-surface for receiving an electrophotographic latent image thereon, wherein the imaging member comprises
a substrate;
a charge generation layer;
a charge transport layer disposed on the charge generation layer, wherein the charge transport layer comprises a charge transport molecule having a Formula I 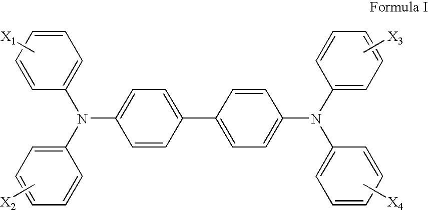
wherein each X₁, X₂, X₃ and X₄ is, independently, selected from alkyl, alkoxy, and halogen; and
a charge stabilizing compound comprising an alkylated amine formaldehyde compound;
b) a development component for applying a developer material to the charge-retentive surface to develop the electrophotographic latent image to form a developed image on the charge-retentive surface;
c) a transfer component for transferring the developed image from the charge-retentive surface to a copy substrate; and
d) a fusing component for fusing the developed image to the copy substrate.

16. The image forming apparatus of claim 15, wherein the charge transport molecule is present in an amount of from about 1 percent weight to about 65 percent weight of the total weight of the charge transport layer.

17. The image forming apparatus of claim 15, wherein each X₁, X₂, X₃ and X₄ is alkyl.

18. The image forming apparatus of claim 15, wherein each X₁, X₂, X₃ and X₄ is methyl.

19. The image forming apparatus of claim 15, wherein the alkylated amine formaldehyde is selected from methylated urea formaldehyde, butylated urea formaldehyde, methylated melamine formaldehyde, butylated melamine formaldehyde, methylated benzoguanamine formaldehyde, butylated benzoguanamine formaldehyde, methylated glucoluril, and mixtures thereof.

20. The image forming apparatus of claim 15, wherein the alkylated amine formaldehyde is present in an amount of from about 0.05 percent to about 10 percent weight of the total weight of the charge transport layer.
